(19) United States
(12) Patent Application Publication
(10) Pub. No.: US 2010/0013833 A1
(43) Pub. Date: Jan. 21, 2010

(54) SYSTEM AND METHOD FOR MODIFYING FEATURES IN A SOLID MODEL

(76) Inventors: Mallikarjuna Gandikota, Maharashtra (IN); Aditya N. Gurushankar, Huntsville, AL (US); Howard Mattson, Impington (GB); Peter Nanson, Cambridge (GB); John C. Owen, Cambridge (GB); Prasad Pingali, Madison, AL (US); Daniel C. Staples, Madison, AL (US); Jeffrey A. Walker, Huntsville, AL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/422,410

(22) Filed: Apr. 13, 2009

Related U.S. Application Data
(60) Provisional application No. 61/044,622, filed on Apr. 14, 2008.
(60) Provisional application No. 61/044,671, filed on Apr. 14, 2008.

(51) Int. Cl. G06T 17/00

(52) U.S. Cl. 345/420

(57) ABSTRACT

A system, method, and computer program for modifying a solid model representation that is manipulated in a computer having software instructions for design, comprising: a computer system, wherein the computer system includes a memory, a processor, a user input device, and a display device; a computer generated geometric model stored in the memory in the memory of the computer system; and wherein the computer system accesses at least one data file having a plurality of geometric model definitions; converts the geometric model definitions into a visual representation of a geometric model; identifies an edit feature for modification on a body of the geometric model; calculates a modified geometric model with the modified edit, wherein the computer system removes the edit feature from an original body of the geometric model; creates a mapping for a plurality of faces from the edit feature to a new edit feature; applies the new edit feature to the original body, wherein the new edit feature is remapped to a new body and the new body is modified; and integrates the new feature with the modified geometric model; and appropriate means and computer-readable instructions.

### CROSS-REFERENCE TO RELATED APPLICATIONS

This Application claims priority to pending Provisional U.S. Applications Ser. Nos. 61/044,622 and 61/044,671, both filed on Apr. 14, 2008.

### TECHNICAL FIELD

The system of the innovations described herein relates generally to computer-aided design software applications. More specifically, the system relates to recognizing geometric relationships in a solid model representation.

### BACKGROUND

In today's world of computer-aided design (CAD) applications, parts are commonly designed in one of two ways: history-based or history-less. A history-based system is commonly characterized by the parametric modeling paradigm that emerged in the mid-1980s. In parametric modeling systems, a recipe, or history tree, is created to reflect how things are related to one another. When a change is made to one original item, all items created later in time from the original item are updated. In this way, for example, two faces may remain coplanar, because they were designed with such a relationship captured during the design process and simply “replayed” during the update process. FIGS. 1a-1c illustrate a trimetric projection of a three-dimensional block. Referring to FIG. 1a, a C block 100 in three-dimension (“3D”) is viewable to a user on a computer display and is in need of a modification by a user by altering a bottom leg 105, a top leg 110, or both the bottom leg 105 and the top leg 110. In a history-based system, how easily the user modifies the C block 100 depends upon how it was originally designed in the CAD application system, such as SolidEdge by Siemens Product Lifecycle Management Software Inc. Commonly, an original designer creates and/or designs a part that is later modified by a modify designer who maybe completely unfamiliar to the original designer. For example, if the original designer, i.e., the person that originally designed the C block 100, had the design method intent to constrain the faces related to the bottom leg 105 and the top leg 110 as coplanar, then the modification action illustrated in FIG. 1c is easy to accomplish using known parametric/history-based modeling techniques that are basic to one skilled in the art of 3D model design, but for simple explanation because the two faces are constrained to be coplanar, moving one face will cause the other face to move as well. If on the other hand, the modify designer intends to move only the face associated with the bottom leg 105 while leaving the top leg 110 alone, e.g., FIG. 1b, then several additional steps must transpire to remove the coplanar constraint requiring several additional steps that begins with understanding how the two legs of the C block 100 were created if the modify designer was not the original designer. Furthermore, if the original designer of the C block 100 did not model the bottom leg 105 and the top leg 110 to be coplanar but modeled the legs by some other method such as a distance or a formula, then to modify both as seen in FIG. 1c would increase the difficulty to a point where the modify designer may as well model the C block 100 from scratch.

On the other hand, modifying the C block 100 in a history-less or the body-based approach taken by companies like CoCreate, IronCAD, and Kubotek, for example, fails to maintain the history-tree made popular by the parametric modeling paradigm. In the history-less approach, changes are made explicitly for each item on a solid model. If the original designer of the C block 100 intended that the faces on the bottom leg 105 and the top leg 110 maintain a coplanar relationship, later modifications require the manual selection of the faces for edit to ensure the desired result, which is difficult if the original designer's intent is unknown or unascertainable. For example, the modify designer can make either change illustrated in FIG. 1b or FIG. 1c simply be selecting the one face or individually select all of the other coplanar faces, which happens to be a small number in this example but could be in the hundreds in a complex assembly model. Alternatively, some software applications could allow the modify designer to “make faces coplanar” and permanently capture the design intent after the fact at time of edit, but this can also be cumbersome particularly with very large models. This later alteration would make the modification see in FIG. 1b difficult at a later date particularly since now the design intent may be baked into the model contrary to design intent.

The issue with the history-based approach is that design intent is incorporated and fixed at the time of model creation, which can complicate making changes later-on that were not anticipated at the time of model creation. In contrast, the history-less systems are flexible about change at a later date, but capture very little intelligence about how things are related. If modify designers determine to manually capture such intelligence at a later point in time, then, like history-based systems, that intelligence is incorporated and fixed thereby limiting further flexibility.

The inventors have advantageously recognized a need for a system and method to provide direct edit capabilities on a solid model where the current geometry is examined and joined with various model constraints so that dependencies are localized in real-time.

### SUMMARY

To address the identified need and related problems, a system provides a system for modifying a solid model representation that is manipulated in a computer having software instructions for design, comprising a computer system, wherein the computer system includes a memory, a processor, a user input device, and a display device; a computer generated geometric model stored in the memory in the memory of the computer system; and wherein the computer system accesses at least one data file having a plurality of geometric model definitions that define a geometric model; converts the geometric model definitions into a visual representation of the geometric model; displays the visual representation of the geometric model to a user; identifies an edit feature for modification on a body of the geometric model; calculates a modified geometric model with the modified edit feature to display to the user, wherein the computer system removes the edit feature from an original body of the geometric model; creates a mapping for a plurality of faces from the edit feature to a new edit feature; applies the new edit feature to the original body, wherein the new edit feature is remapped to a new body and the new body is modified; and integrates the new feature with the modified geometric model; displays the modified geometric model to the user.

Other features of the system are set forth in part in the description and in the drawings that follow, and, in part are learned by practice of the system. The system will now be described with reference made to the following Figures that form a part hereof. It is understood that other embodiments may be utilized and changes may be made without departing from the scope of the system.

### BRIEF DESCRIPTION OF THE DRAWINGS

A system will hereinafter be described in conjunction with the appended drawings, wherein like designations denote like elements, and:

FIGS. 1a-1c illustrate a trimetric projection of a three-dimensional block;

FIG. 2 is a process diagram of a method employed by the system;

FIG. 3 is a block diagram of a computer environment in which the system may be practiced;

FIG. 4 illustrates a general concept of a software programming code embodied in a software application;

FIG. 5 is a box diagram of a general view of a method employed by the embodiment;

FIG. 6 illustrates an exemplary solid model modification system;

FIG. 7 is a sequence diagram for an exemplary solid model modification system;

FIGS. 8a-d illustrate a general edit operation of an API in an exemplary solid model modification system; and

FIGS. 9a-d illustrates an algorithm for updating a procedural feature.

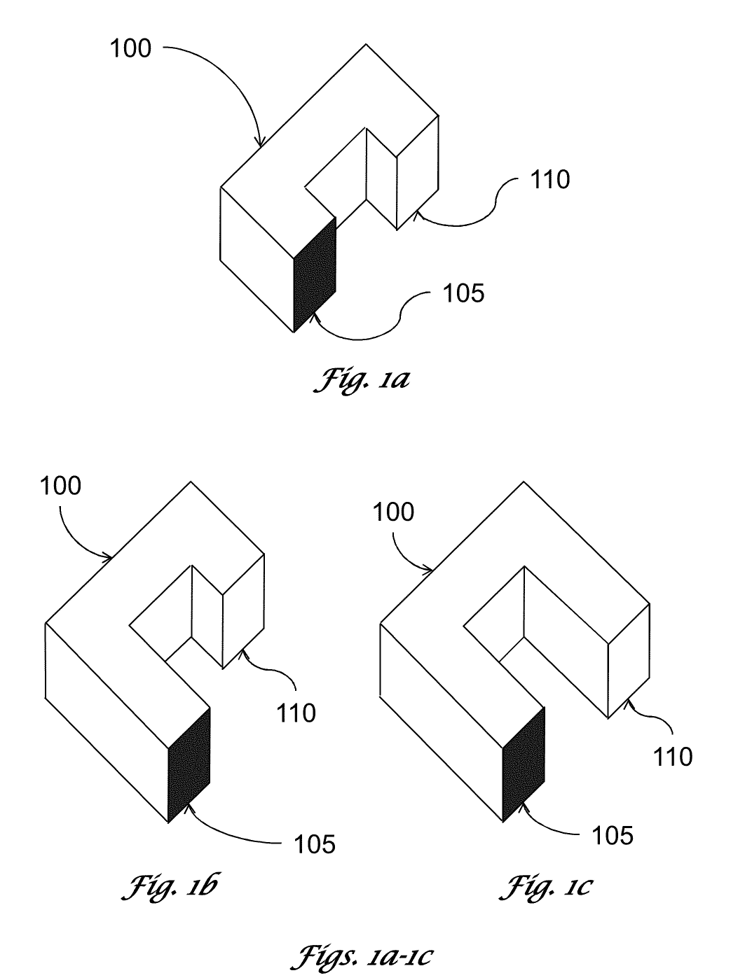

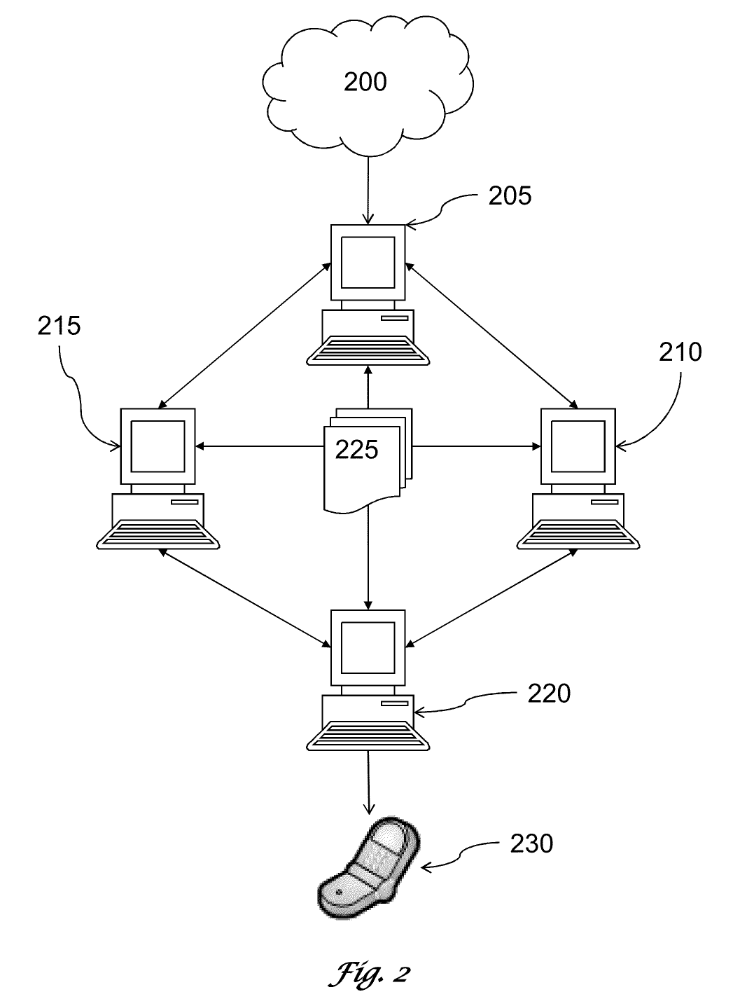

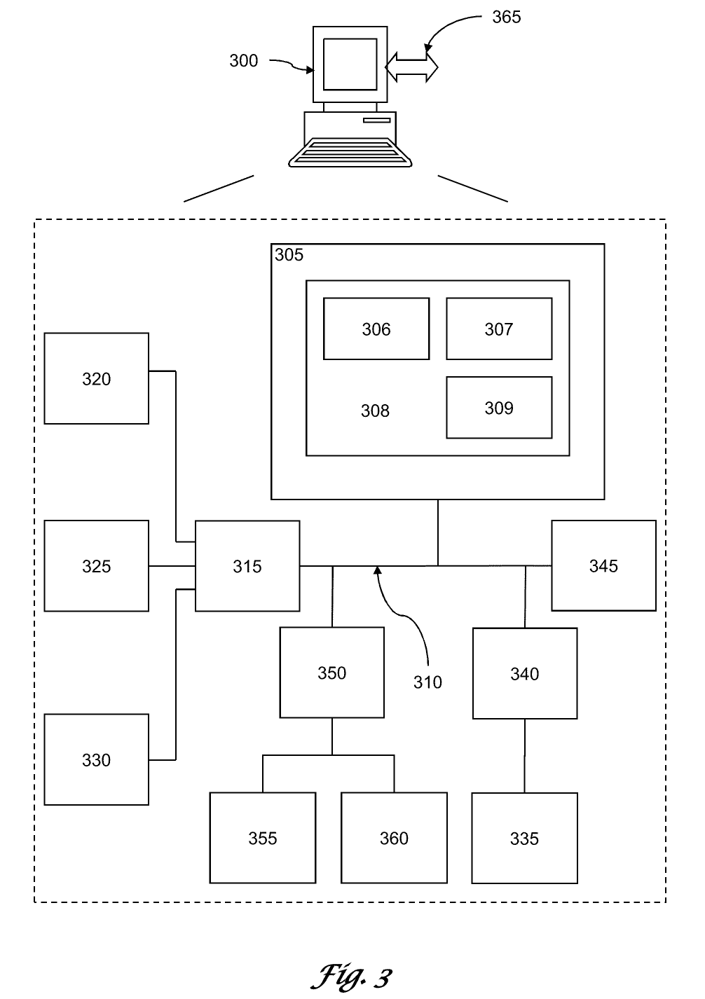

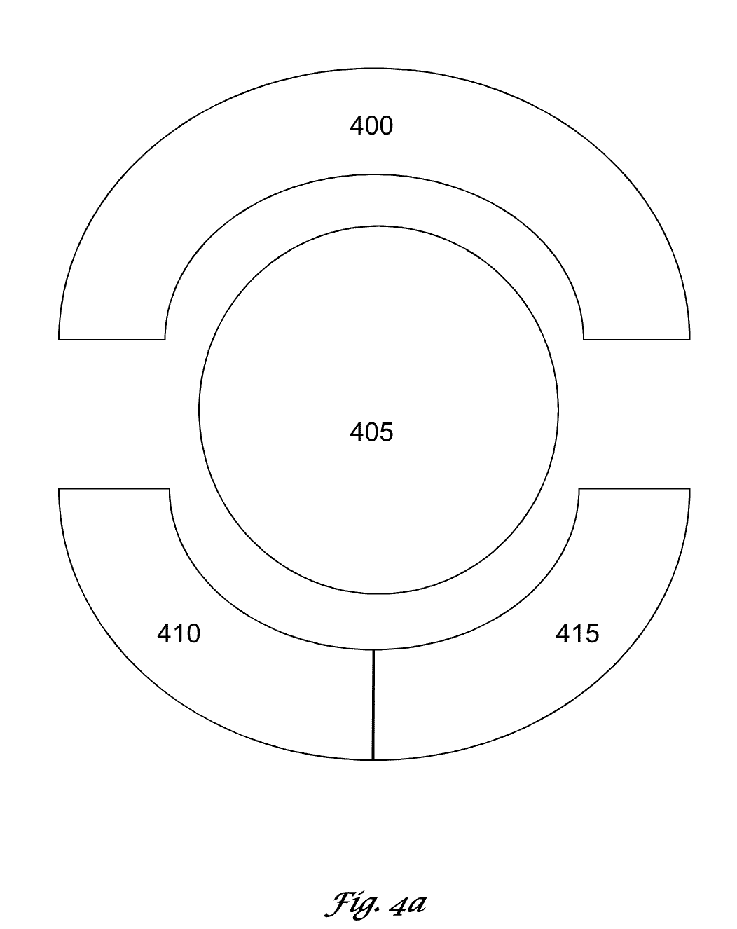

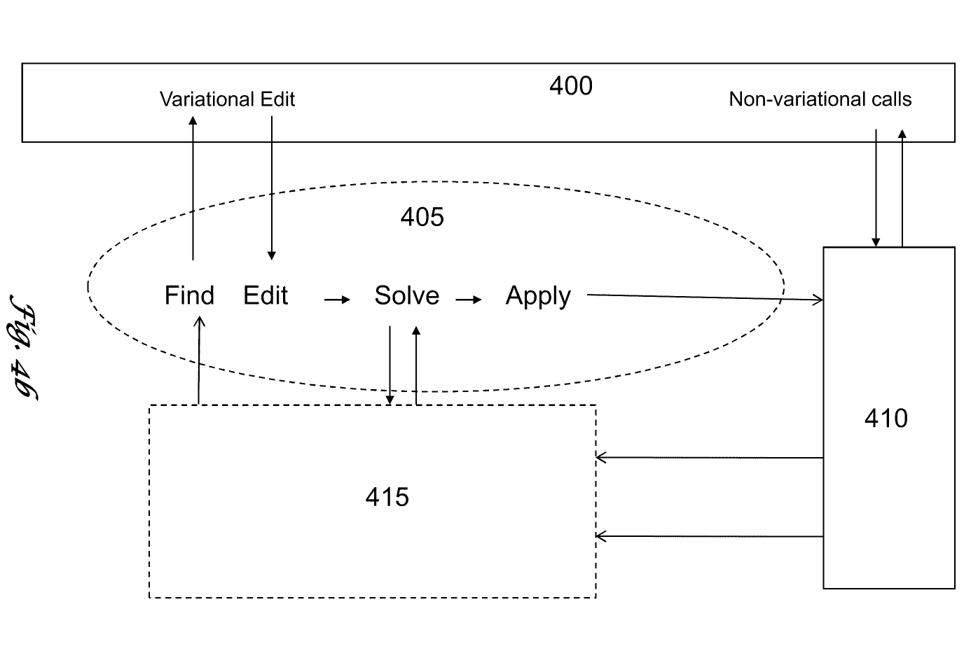

### DETAILED DESCRIPTION OF THE PREFERRED EMBODIMENTS

### 1. Introduction

A method and system for modifying geometric relationships in a solid model are described. In the following description, for the purposes of explanation, numerous specific details are set forth in order to provide a thorough understanding of the system. It will be apparent, however, to one skilled in the art that the system may be practiced without these specific details. In other instances, well-known structures and devices are shown in block diagram form in order to avoid unnecessarily obscuring the system.

FIG. 2 illustrates a sample virtual product development environment. The virtual development environment employed today typically begins with a customer request, or an innate desire, to create or improve upon a product, generally shown at 200. That product can be as simple as a bottle opener or as complex as a submarine. Referring further to FIG. 2, an original designer models a desired product according to known methods employed by a computer-aided design (CAD) application 205, The CAD application 205 is executed on a general computing machine which subsequently becomes a specific purpose computing environment for the sake of executing computer-aided design routines at the time of application execution and interaction, the details of which are discussed below. The CAD application 205 is preferably SolidEdge or NX both offered for license by Siemens Product Lifecycle Management Software Inc. A CAD user operates the CAD application 205 in a well known and understood manner so as to virtually display a solid model that resembles and conforms to an original design requirement ascertained from the customer request or the innate desire. The solid model is commonly an assembly of components and assemblies, where the assemblies are further broken down into sub-assemblies and/or components, all preferably having a virtual representation stored for subsequent recall in solid model data files 225.

Once the solid model is determined to be in a suitable form comporting to the original design requirements, it is preferably tested using a computer-aided engineering (CAE) application 210 such as NX CAE or FEMAP offered by Siemens Product Lifecycle Management Software Inc by a CAE user for part fault-tolerance tests and a variety of other engineering tests. If the CAE user determines that the solid model has to be modified to successfully pass the fault-tolerance tests the solid model is returned to the CAD user for modification in the CAD application 205. This iteration between the CAD application 205 and the CAE application 210 and the respective users is recursive until the solid model successfully passes necessary design requirements and engineering test.

Following successful completion, the solid model in its final design form is further designed for physical manufacture in a computer-aided manufacturing (CAM) application 215 such as NX CAM or CAM Express both offered by Siemens Product Lifecycle Management Software Inc. By using the CAM application 215, a CAM user will model how numerical control programs, molds, tools and dies manufacture a physical product 230. The CAM user may have additional modifications to comport to the original design requirements, for example, using electro-discharge machining (EDM) may require different techniques depending if a wire-cut EDM or die-sinking EDM is used to manufacture the physical product 230. To virtually mill a part, the CAM application 215 defines the preferably electrode path of the orbit for the EDM process. The CAM user may determine that in order to comport to design and engineering requirements, the solid model requires a subtle modification in dimensions, for example following a cool-down to allow for hardening of the material comprising the physical product 230.

Following the successful virtual designing, engineering, and manufacturing of the product, a manufacturer can link all manufacturing disciplines with product engineering related to the product including: process layout and design, process simulation/engineering, and production management utilizing a digital factory application 220 such as Tecnomatix offered by Siemens Product Lifecycle Management Software Inc. The manufacturer may find the need to modify the physical product 230 because the CAM users modeled the product with, for example, an EDM system that is outdated and requires the manufacturer to use a 5-axis turning machine to create the necessary blank or the manufacturer has shifted to injection molding rather than compression molding to form the parts that comprise the physical product 230. For example, the solid model has to be modified to comport to the final requirements to manufacture the physical product 230.

Throughout the virtual product development described above, the product design flowed for example from the customer request to the CAD user to the CAE user to the CAD user, back to the CAE user, to the CAM user, and then to the Manufacturer for physical production of the physical product 230. With each edit to the solid model, geometric relationships are also modified so as to comport to the necessary design changes by the CAD user, the CAE user, the CAM user, and the Manufacturer, for example. Further as each of the CAD/CAE/CAM users modify the solid model, a data model that defines the solid model is also modified to properly account for the changes discussed above and properly stored in the solid model data files 225. The manufacturer then proceeds to produce the physical product 230 according to the original design specifications and subsequent engineering modifications. The virtual product development occurs in a system, where the system and method for modifying geometric relationships in a solid model is executable in a variety of software applications resident in memory on a variety of hardware systems, described in more detail below.

### 2. Computer Program Product

Turning now to a hardware system, FIG. 3 is a block diagram of a computer system in which the system may be practiced. FIG. 3 and the following discussion are intended to provide a brief, general description of a suitable hardware system and computing environment in which the embodiment may be implemented. The embodiment may be performed in any of a variety of known computing environments.

Referring to FIG. 3, an exemplary computer system includes a computing device in the form of a computer 300, such as a desktop or laptop computer, which includes a plurality of related peripheral devices (not depicted). The computer 300 includes a central processing unit (CPU) 305 and a bus 310 employed to connect and enable communication between the central processing unit 305 and a plurality of components of the computer 300 in accordance with known techniques. The operation of the CPU 305 is well understood in the art that is preferably an electric circuit that can execute computer programs having computer-executable instructions encoded thereon, such as program modules, which are executed by the computer 300. Generally, program modules include routines, programs, objects, components, data structures, etc., that perform particular tasks or implementation particular data types. Preferably the program modules include a file processing module 306, a data display module 307, a logic processing module 308, and a method processing module 309. The logic processing module 308 sends requests to the file processing module 306, the data display module 307 and the method processing module 309 to operate according to the computer-executable instructions. Likewise the logic processing module receives requests from the file processing module 306, the data display module 307 and the method processing module 309 to operate according to the computer-executable instructions. The bus 310 also enables communication among the various program modules and the plurality of components. The bus 310 may be any of several types of bus structures including a memory bus or memory controller, a peripheral bus, and a local bus using any of a variety of bus architectures. The computer 300 typically includes a user interface adapter 315, which connects the central processing unit 305 via the bus 310 to one or more interface devices, such as a keyboard 320, mouse 325, and/or other interface devices 330, which can be any user interface device, such as a touch sensitive screen, digitized pen entry pad, etc. The bus 310 also connects a display device 335, such as an LCD screen or monitor, to the central processing unit 305 via a display adapter 340. The bus 310 also connects the central processing unit 305 to a memory 345, which can include ROM, RAM, etc.

The computer 300 further includes a drive interface 350 that couples at least one storage device 355 and/or at least one optical drive 360 to the bus. The storage device 355 can include a hard disk drive, not shown, for reading and writing to a disk, a magnetic disk drive, not shown, for reading from or writing to a removable magnetic disk drive. Likewise the optical drive 360 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 300 that is accessible by the file processing module 306 according to instructions received by the logic processing module 308 in the method described by instructions provided by the method processing module 309.

The computer 300 can communicate via a communications channel 365 with other computers or networks of computers. The computer 300 may be associated with such other computers in a local area network (LAN) or a wide area network (WAN), or it can be a client in a client/server arrangement with another computer, etc. Furthermore, the embodiment may also be practiced in distributed computing environments where task instructions provided by the logic processing module 308 in the method described by instructions provided by the method processing module 309 and are performed by remote processing devices that are linked through a communications network. In a distributed computing environment, the program modules may be located in both local and remote memory storage devices. All of these configurations, as well as the appropriate communications hardware and software, are known in the art.

Turning now to the program modules in more detail, FIGS. 4a-4b illustrate a general concept of a software programming code embodied in a software application. Referring further to FIG. 4a, the program modules will be described in more detail below in the context of the embodiment where a software application 400 contains accessible program modules as those discussed above. The software application 400 may be in the form of a solid modeling application such as the aforementioned CAD application 205, the CAE application 210 or CAM application 215. Further it is contemplated that the software application 400 is provided by a third party vendor with particular API (“application programming interface” call features for access and utilization. Continuing, as the user interacts with the software application 400, certain modification events trigger interaction with a variational modeling toolkit 405, to be discussed in greater detail below. The software application 400 and the variational modeling toolkit 405 together or individually utilize the logic processing module 308 in the method described by instructions provided by the method processing module 309 to call a low-level geometric modeling kernel to accomplish the certain modification events of the solid model according to the commands selected by the user and executed by the software application 400, as generally understood in the art of solid modeling, but also discussed in more detail below. The low-level geometric modeling kernel is commonly a collection of at least a three-dimensional (3D) geometric modeler 410 like Parasolid licensed by Siemens Product Lifecycle Management Software Inc and a collection of geometric software component libraries 415 like the 3D DCM (or “DCM” product offered by Siemens Product Lifecycle Management Software Inc.

Put another way, referring to FIG. 4b, the variational modeling toolkit 405 operates on variational edit commands communicated from the software application 400. Additionally, the software application 400 communicates non-variational modeling calls to the 3D geometric modeler 410, and the 3D geometric modeler 410 utilizes the collection of geometric software component libraries 415 as normally understood in the art of geometric modelers. With regard to the variational modeling toolkit 405, and to be discussed in greater detail below, several operations occur related to the variational edit that involve find, edit, solve and apply. It is commonly understood in the art of solid modeling that the collection of geometric software component libraries above provides modeling functionality such as geometric constraint solving, variational design, parametric design, motion simulation, collision detection, clearance computations, topology location, topology move solution, and hidden line removal, for example. It is also contemplated to be within the scope of this embodiment that the 3D geometric modeler 410 and the component libraries 415 are components of the same application rather than separate components, or combinations thereof. Having described the computer program product, more detail is now provided with regard to a system.

### 3. A Model Modification System

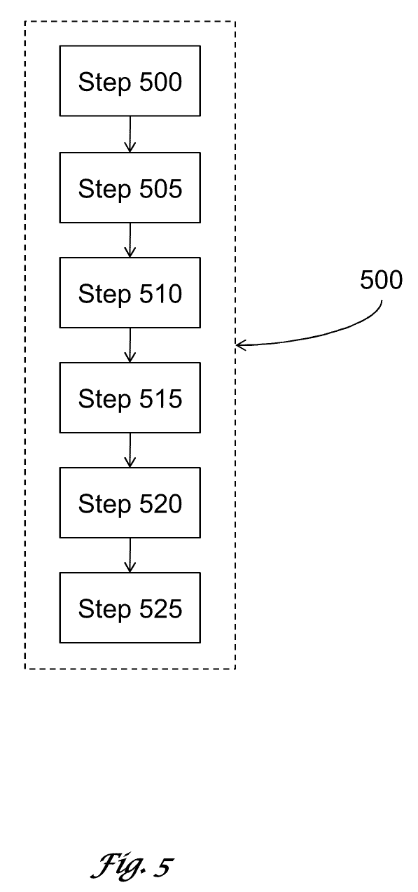

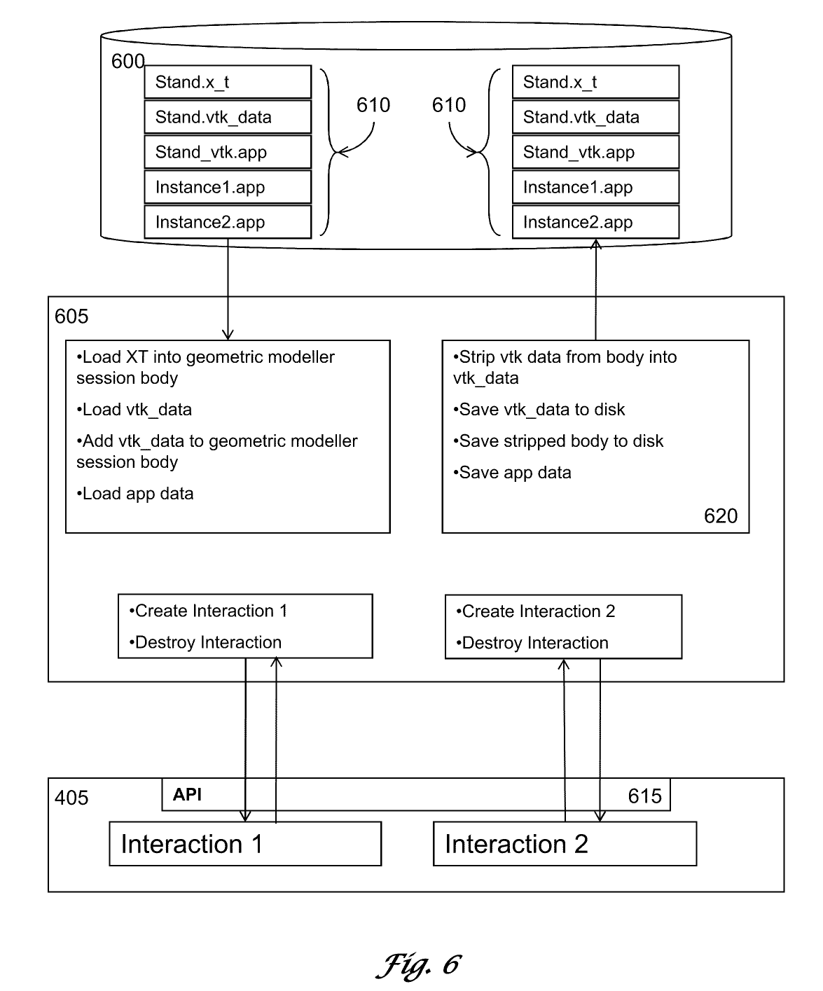

Turning now to the solid model modification system, FIG. 5 is a box diagram of a general view of a method employed by the embodiment. Referring to FIG. 5, the embodiment discloses the logic processing module 308 using the method described by instructions provided by the method processing module 309, where the described method is a method for modifying geometric relationships in a solid model representation that is manipulated in a computer having software instructions for design, generally depicted at 500. The following steps are mentioned to provide an overview of the embodiment described in the system having details that are subsequently discussed. The system accesses a data file defining a geometric model (Step 500). The system converts the data file definitions into a visual representation of the geometric model, wherein the visual representation is in a boundary representation format (Step 505). The system displays the visual representation of the geometric model to a user (Step 510). The system identifies an edit feature for modification on a body of the geometric model (Step 515). The system calculates a modified geometric model with the modified edit feature to display to the user (Step 520). The system displays the modified geometric modeler to the user (Step 525). In Step 520, the system removes the edit feature from an original body of the geometric model, creates a mapping for a plurality of faces from the edit feature to a new edit feature; applied the new edit feature to the original body, wherein the new edit feature is remapped to a new body and the new body is modified; and integrates the new feature with the modified geometric model. It is preferred that the edit feature refers to the feature of a solid model under edit.

FIG. 6 illustrates an exemplary solid model modification system. The user using the software application 400 executes the necessary commands for the software application 400 to access the storage device 355 that is preferably a hard disk drive 600 having data related to a virtual representation of a solid model stored in the solid model data files 225 that are preferably accessible by the software application 400, the variational modeling toolkit 405, the 3D geometric modeler 410 and the collection of geometric software component libraries 415. Referring further to FIG. 6, the software application 400 is characterized by a solid modeling application 605 that utilizes the file processing module to access the solid model data files 225 structured preferably as data files 610 stored on the hard disk drive 600 in preferably a stand.x_t format that refers to a modeler transmit file type for the 3D geometric modeler 410, a stand.vtk_data format that refers to a variational modeling toolkit information file type for the variational modeling toolkit 405, where stand* refers to a generic part file name. The solid modeling application 605 has its own recognized file type extensions, for example APP, which it uses to obtain sufficient information for manipulation of the solid model. Continuing, the solid modeling application 605 loads the stand.x_t file into a 3D geometric modeler session body to be accessed by the 3D geometric modeler 410. The stand.vtk_data file is loaded and added to the 3D geometric modeler session body. The solid modeling application 605 loads the application data relating to the solid model and accesses the data files 610 according to its own file type, for example PRT. Once the interaction has been created, to be discussed later, the variational modeling toolkit 405 handles the modification computations by way of the variational modeling toolkit API 615, which is discussed in more detail below. Following the solid model modification, in order to save the modified solid model to the hard disk drive 600, block 620 illustrates the data related to the variational modeling toolkit 405 is striped from the solid model and placed into a vtk_data data structure that is then saved to the stand.vtk_data file. The stripped solid body is also saved to the hard disk drive 600, as is the application data.

### 4. A Model Modification Method

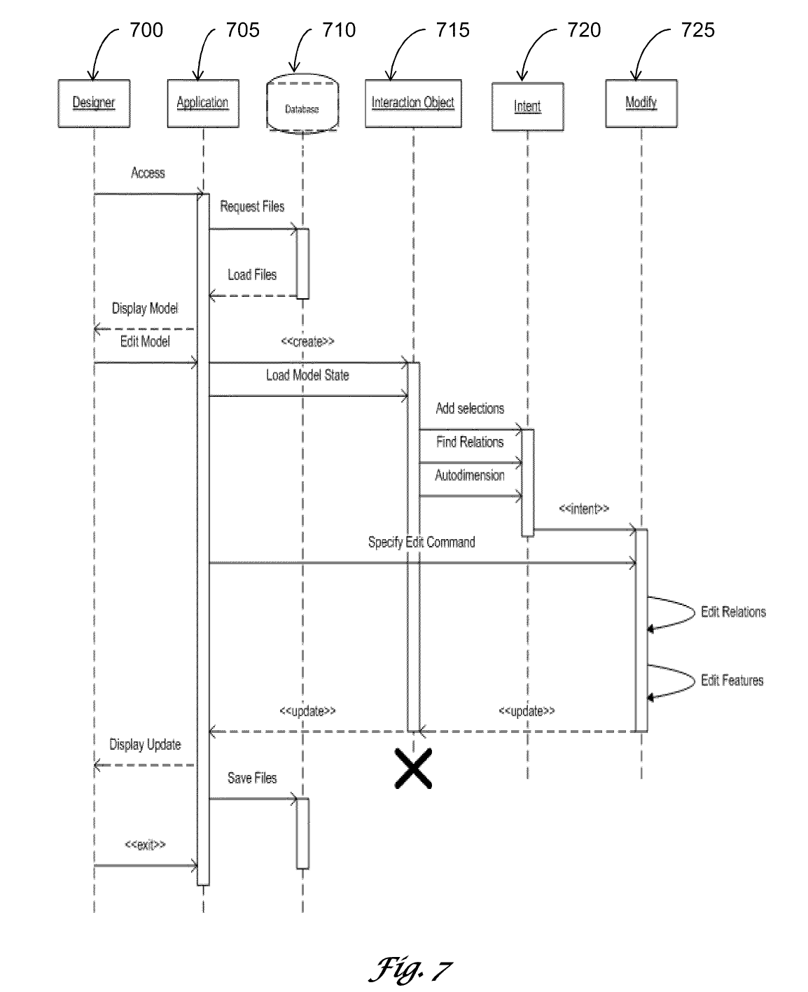

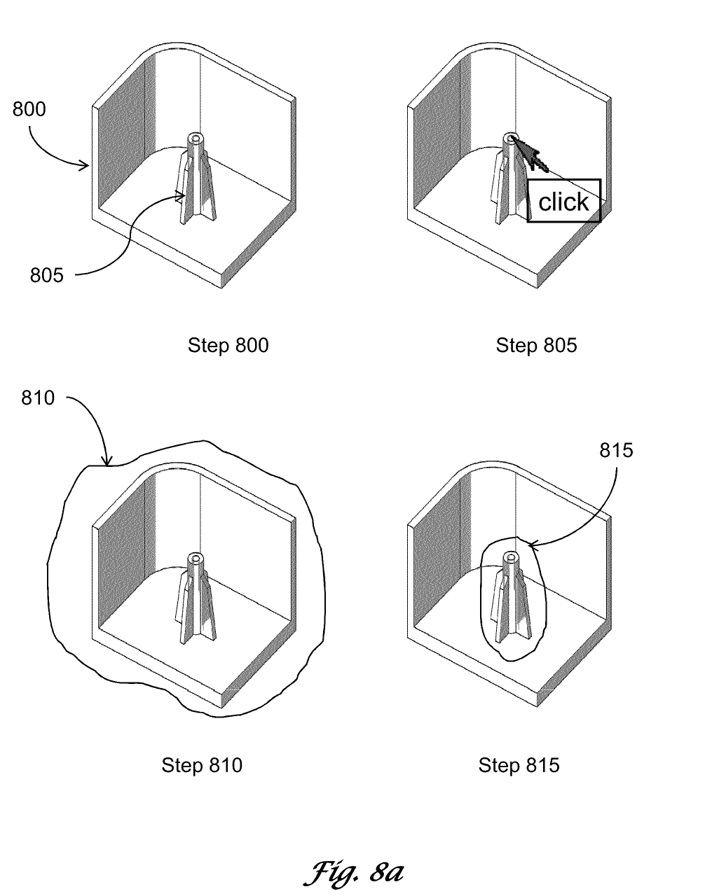

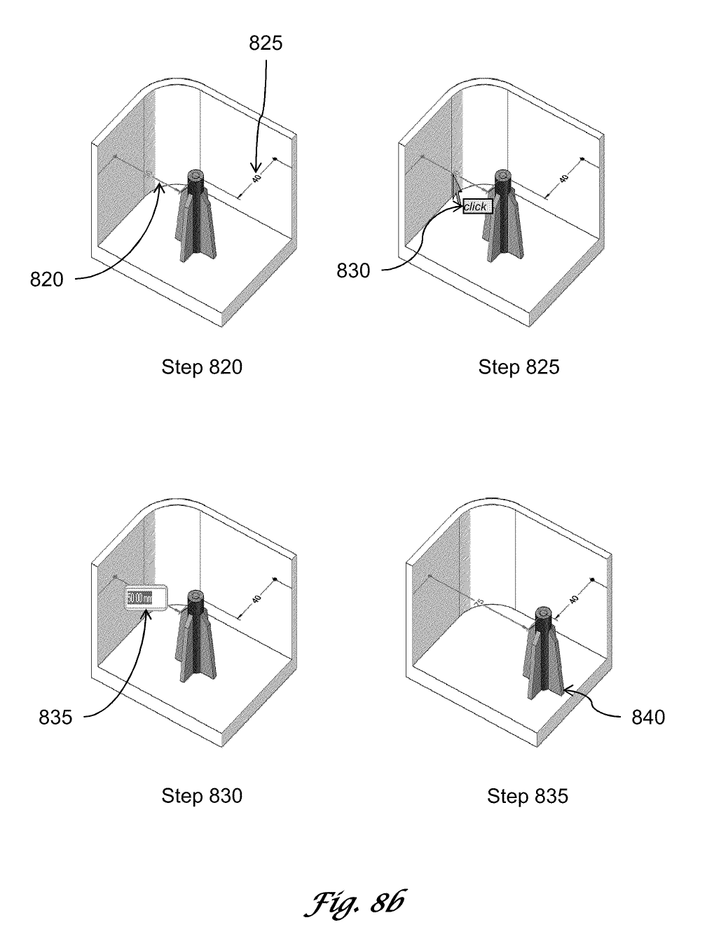

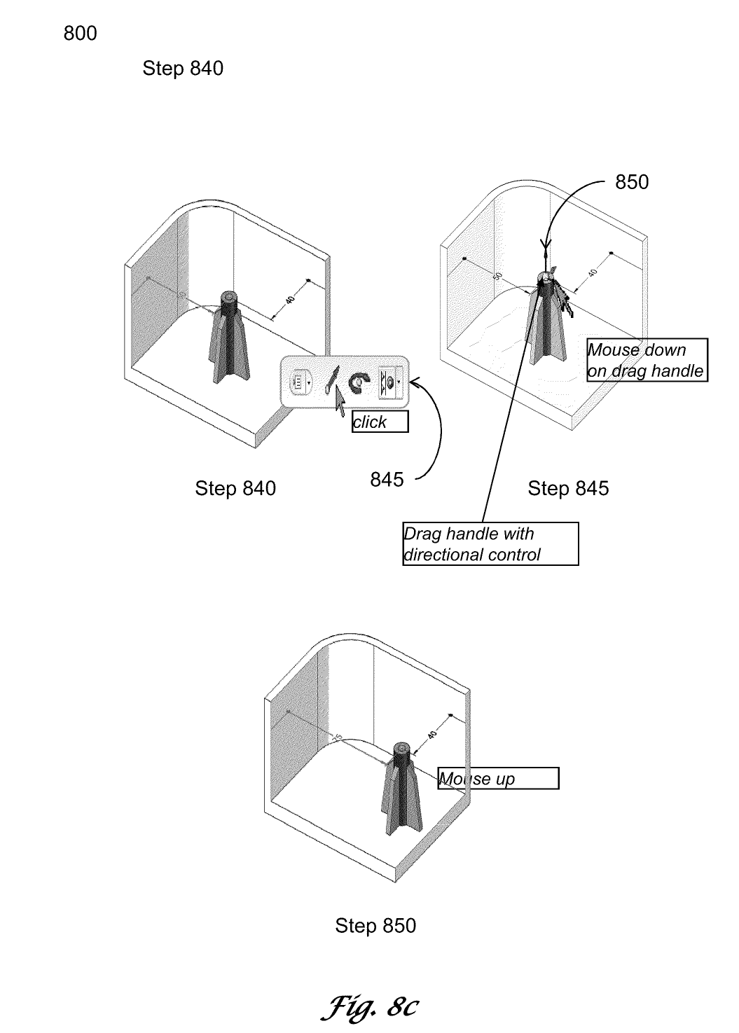

FIG. 7 is a sequence diagram for an exemplary solid model modification system. Referring further to FIG. 7, a designer 700, e.g., the user, access an application 705, e.g., the solid modeling application 605, to modify a solid model. The application 705 access a solid model database 710 preferably located on the hard disk drive 600 to access the a solid model for modification determined by the designer 700. The solid model database 710 returns the data files 610 corresponding to the designer's request that are loaded by the application 705. The application then loads the solid model for display to the designer 700, at which time the designer 700 intends to modify some portion of the solid model where it is understood that the solid mode does not have a history tree. The application 705 then creates an interaction object 715 with the variational modeling toolkit 405 in order to express a particular model state of the solid model. The interaction object 715 is returned as a tag that is supplied for all subsequent calls on the interaction data structure functions, sample pseudo-code provided by:

typedef int Tag;
typedef Tag InteractionTag;
Interaction Tag CreateInteraction(Interaction Tag*, ResultType*);
void DestroyInteraction(InteractionTag, ResultType*);

As can be seen by the above pseudo-code that not only is the Interaction Object created, but it is also destroyed after model update, which will be discussed in more detail below. For convenience,

#DEFINE IT InteractionTag it
#DEFINE RT ResultType* result

Continuing, it is preferable that the API calls return an error code as a last return argument, indicating success or failure or information, sample pseudo-code provided by:

```
enum ResultType { ResultTypeOK,ResultTypeBadArgument,
ResultTypeUnknown, ResultTypeUnhandledException};
typedef Tag ErrorTag;
ResultType result = ResultTypeOk;
ReferenceTag ref = RelationGetReference(it,relation,index,&result);
If (result != ResultType Ok)
{
  ErrorTag etag = GetError (it);
  int data1 = ErrorGetCount(it,etag);
  ... /* dig out multiple error data */
  DestroyError(it,etag); // or possibly DestroyObject
}
```

The application 705 communicates the particular model state of the solid model design to the variational modeling toolkit 405 via the interaction data structure, where the model state includes information such as instances, parts, profiles, constraints, dimensions, options, etc. The term “instance” refers to a well-known term in the art of geometric modeling, regardless it is a particular occurrence of a solid body at a particular location within the application 705, where the instance comprises a body and a transform. The term “transform” refers to a rigid body transformation usually expressed as a 4×4 matrix (“[4][4]”) when passed in or out of the API, and is also well understood in the art. The instances created during the interaction places parts in a consistent place, sample pseudo-code given by:

typedef Tag InstanceTag;
typedef Tag PartTag;
InstanceTag CreateInstance(IT,Tag Part, double Transform[4][4], RT);
PartTag InstanceGetPart(IT,InstanceTag, RT); // part could be a wire /
profile
void InstanceGetTransform(IT,double Transform[4][4], RT);
int GetInstanceCount(IT,RT);
InstanceTag GetInstance(IT, int index, RT);

The “part” could be a wire part that may also be specially marked as a profile, for example. Because there are part instances in the variational modeling toolkit 405, it is preferable to express the occurrence of a feature set, where the feature set is a set of topology that includes at least a face, edge, and/or vertex (FEV), in a particular instance, or a FEV instance. The FEV instance is called a “reference” and it is obtained by holding an FEV tag and an instance tag. References are preferably used in the API rather than raw FEV tags. References can be fixed or not, sample pseudo-code given by:

typedef Tag ReferenceTag;
typedef Tag EntityTag; // face, edge, vertex, geom
ReferenceTag CreateReference(IT,EntityTag,InstanceTag, RT);
Tag ReferenceGetEntity(IT,ReferenceTag, RT);
InstanceTag ReferenceGetInstance(IT,ReferenceTag, RT);
void ReferenceSetFixed(IT,ReferenceTag,bool Fixed,RT);
bool ReferenceGetFixed(IT,ReferenceTag,RT);
ReferenceTag GetReference(IT,Tag entity,InstanceTag,RT);

A “relation” constrains or dimensions one or more geometric entities, where preferable relations are coincident, concentric, parallel, perpendicular, tangent, and symmetric. Sample pseudo-code is given by:

typedef Tag RelationTag;

| | | |
|---|---|---|
| enum RelationType | {RelationTypeCoincident, | RelationTypeConcentric, |
| RelationTypeParallel, | RelationTypePerpendicular, | RelationTypeTangent, |
| RelationTypeSymmetric, | RelationTypeDistance, | RelationTypeAngle, |

RelationTypeEqualRadius, ...}
RelationTag CreateRelation(IT,RelationType, RT);
void RelationAddReference(IT,RelationTag,ReferenceTag,RT);
int RelationGetReferenceCount(IT,RelationTag, RT);
ReferenceTag RelationGetReference(IT,RelationTag, int index, RT);
RelationType RelationGetType(IT,RelationTag, RT);
double RelationGetValue(IT,RelationTag, double*);
int GetRelationCount(IT, RT);
RelationTag GetRelation(IT, int index, RT);

The relation is preferably persisted longer than the interaction object 715. This persistence is preferably handled by the variational modeling toolkit 405 when the relation is within a single part that has one instance. Other persistence situations are handled by the application 705, sample pseudo-code given by:

void RelationSetPersistent(IT, RelationTag, bool Persistent, RT);
bool RelationGetPersistent(IT, RelationTag, RT);

Continuing, the relation is valid if all of its references are valid and the geometric combination is valid for the relation type. The relation can become invalid, however, as a ResultType of modeling, e.g., a radius-to-cylinder becomes invalid when cylinder changes to cone. The relation is up to date if it is valid and a solve has been attempted. The relation is satisfied if it is valid, up to date, and is currently geometrically satisfied in the solid model design. If the relation is valid and up to date, but not satisfied, then it is preferably over-constrained or inconsistent in the context of other relations, given by the following sample pseudo-code:

bool RelationGetValid(IT,RelationTag, RT);
bool RelationGetUpToDate(IT,RelationTag, RT);
bool RelationGetSatisfied(IT,RelationTag, RT);

Continuing, references can be grouped into rigid sets that are preferably fixed or not, given by the following sample pseudo-code:

typedef Tag RigidSetTag;
RigidSetTag CreateRigidSet(IT, RT);
void RigidSetAddReference(IT,RigidSetTag,ReferenceTag);
int RigidSetGetReferenceCount(IT,RigidSetTag, RT);
ReferenceTag RigidSetGetReference(IT,RigidSetTag,int index, RT);
void RigidSetSetFixed(IT,RigidSetTag,bool Fixed,RT);
bool RigidSetGetFixed(IT,RigidSetTag, RT);
int GetRigidSetCount(IT, RT);
RigidSetTag GetRigidSet(IT, int index, RT);

Profiles are similar to solid bodies in that they preferably hold geometry in a natural coordinate frame and need to be reference via a transform. After creating the profile and creating and adding the geometry to the 3D geometric modeler 410, the application 705 creates the instance (using InteractionCreateInstance) to allow the profile to be positioned and references (using InteractionCreateReference supplying the geometry) for related geometry. Referring again to features, features are a collection of geometry that may be rigid or procedural, discussed below. Features are communicated to the variational modeling toolkit 405; the variational modeling toolkit 405 does not preferably recognize the features. If the features are procedural, it will preferably have a procedure for regeneration based on dependents represented by the following sample pseudo-code:

void FeatureAddReference(IT,FeatureTag,ReferenceTag,RT);
int FeatureGetReferenceCount(IT,FeatureTag, RT);
ReferenceTag FeatureGetReference(IT,FeatureTag, int index,RT);

The geometry of the features is preferably provided by the following pseudo-code:

void FeatureAddReference(IT, FeatureTag, ReferenceTag, RT);
int FeatureGetReferenceCount(IT, FeatureTag, RT);
ReferenceTag FeatureGetReference (IT, FeatureTag, int index RT);

and for rigid features that over-rides procedural features:

void FeatureSetRigid(IT,FeatureTag,bool,RT);
bool FeatureGetRigid(IT,FeatureTag,RT);

A procedural feature is a collection of geometry, topology, parameters, and procedures that form a logical unit. Re-evaluation of the procedural features with revised geometry, topology or parameters will preferably generate new geometry and topology, to be discussed in more detail below. Continuing, for procedural features the application 705 preferably supplies a callback function to call during a solving process and regenerates the procedural geometry preferably based on a current state of dependents, which can is preferably inquired via normal inquiry functions on the ProceduralFeatureTag. Moniker creation and tag recovery are also performed by the application 705 in the callback function. The application preferably passes out a MappingData object (see below) for the application 705 to populate, according to the following sample pseudo-code:

typedef void Procedure(IT, FeatureTag, void *AppData, MappingData
Tag*, <sheet body for new geometry>);
void FeatureSetProcedure(IT, FeatureTag, Procedure, AppData*, RT);
Procedure FeatureGetProcedure(IT, FeatureTag, Procedure, AppData*,
RT);

Procedural features preferably depend upon other geometry communicated to the variational modeling toolkit 405, according to the following sample pseuedo-code:

void FeatureAddDependent(FeatureTag,ReferenceTag,RT);
int FeatureGetDependentCount(FeatureTag,RT);
ReferenceTag FeatureGetDependent(FeatureTag, int index,RT);

Procedural features are pristine if a current incarnation is preferably formed by recreating the procedural feature by removing it from the current model and recreating it with its current parameters and parents. There are times within the processing performed by the variational modeling toolkit 405 where the application 705 recovers new tags from old, for example, when regenerating the procedural feature via the callback function. The general mechanism for communicating the desire to recover is via a MappingData object that is preferably created by the variational modeling toolkit 405 and communicated to the application 705, which calls the necessary functions to populate the MappingData object, given by the following sample pseudo-code:

typedef Tag MappingDataTag;
MappingDataTag CreateMappingData(IT,FeatureTag,RT); - internal
void MappingDataAddEntry(IT,Tag old, Tag new, RT);

Procedural features communicated to the variational modeling toolkit 405 preferably have related regenerate procedures called when necessary, for example, when supporting geometry changes. These features can also have their internal parameters changed that necessitate a feature update even though no supporting geometry has changed, according to the following sample pseudo-code:

void FeatureSetUpdateRequired(IT, FeatureTag, RT);

Once the particular model state has been communicated to the interaction object 715, the API 615 specifies what is to change and what is to be maintained during an intent state 720.

Turning now to the intent state 720, the core of the variational modeling toolkit 405 interaction mode involves selection and recognition. The user selects the FEV set to be changed, the following sample pseudo-code provided:

void AddSelection(IT,ReferenceTag, RT);
int GetSelectionCount(IT, RT);
ReferenceTag GetSelection(IT, RT);

Where inter-instance relations are supplied, it is preferable that there is a way to communicate whether the Face, Edge, or Vertex instance is to move, referred to as a target of the reference and is preferably the same for all unique and for all equal references. Find functions search for relationships among a current selection FEV set and other FEVs in the same and other parts within the interaction object. The found FEVs are gathered from the raw model geometry and topology as well as persistent constraints and dimensions that are present in the interaction object. Newly found relationships preferably maintained and non-permanent by default. The following is sample pseudo-code: void FindRelations(IT,RT). Further Autodimentioning is preferably used to allow behavior control, as described in United States Publication Number 2008/0143708, filed on Dec. 18, 2006, titled “SYSTEM AND METHOD FOR AUTO-DIMENSIONING BOUNDARY REPRESENTATION MODEL.” For example, the option to move a face rather than rotating it will use autodimensioning to try and add defining angles to the face. A more explicit use of autodimensioning by the application 705 is in the general edit scenario where the solid model is not currently fully dimensioned and the designer 700 is offered dimensions as a form of edit handle, which are obtained from a call to the variational modeling toolkit 405. Dimension the remaining freedoms of the selected faces with respect to the rest of the model and within the selection set, with the following sample pseudo-code: void DimensionFreedoms(IT, RT). Now that the application 705 has defined the particular model state, the scope and the changeable entities during the intent state 720, it is now time to direct an edit 725.

Turning to the edit 725, there are various types of edits, for example, change dimension value, add new constraints, drag, thicken, which provides a non-exhaustive list of samples, and various combinations thereof. The application 705 passes the specified type of operation to perform to the variational modeling toolkit 405, for example, the normal pull of a planar face that may need a special function, with sample pseudo-code provided by:

void DragLinearStart (IT,double Pos[3], double Dir [3], double
StartOnLine[3], RT);
void DragLinearStep(IT,double PosOnLine[3], RT);
void DragLinearStop (IT, RT);

Continuing, the application 705 requests an update that is preferably called directly after the modification. After the update, the application 705 queries a new state of instance transforms, relation values, relation validity, for example, to perform the necessary graphics updates for display to the designer 700. As discussed above, consumed faces and entities are maintained by the 3D geometric modeler session body, where the variational modeling toolkit 405 provides for their inquiry, with the following sample pseudo-code:

int GetConsumedEntityCount(IT,RT);
ReferenceTag GetConsumedEntity(IT,int index, RT);

The application 705 takes advantage of a rollback procedure for non-branches, where required rollmarks can be set in the interaction object 715. The rollbacks are then merged with the application 705, with the following sample pseudo-code:

typedef Tag MarkTag;
MarkTag CreateMark(IT, RT);
void RollToMark(IT,MarkTag, RT);
Int GetMarkCount(IT,RT);
MarkTag GetMark(IT,int index, RT);

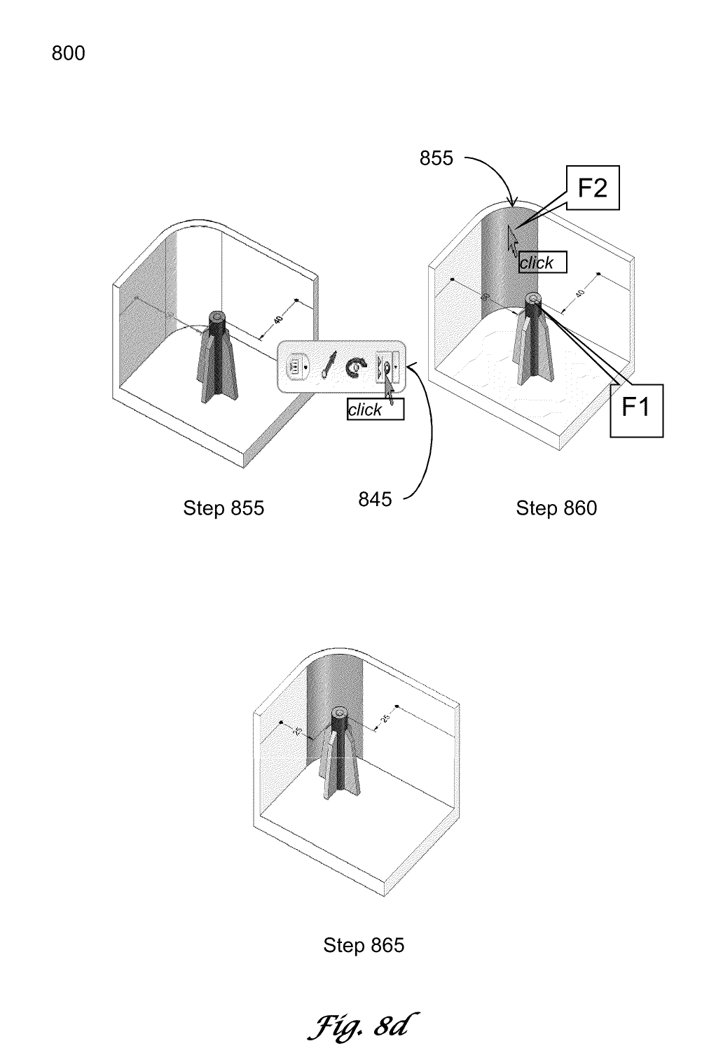

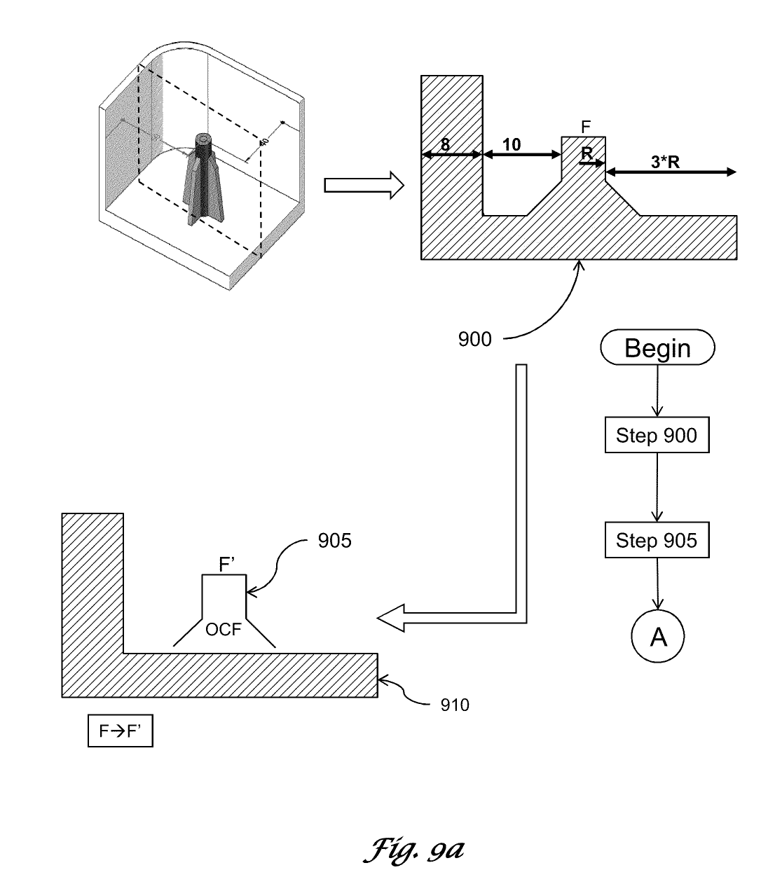

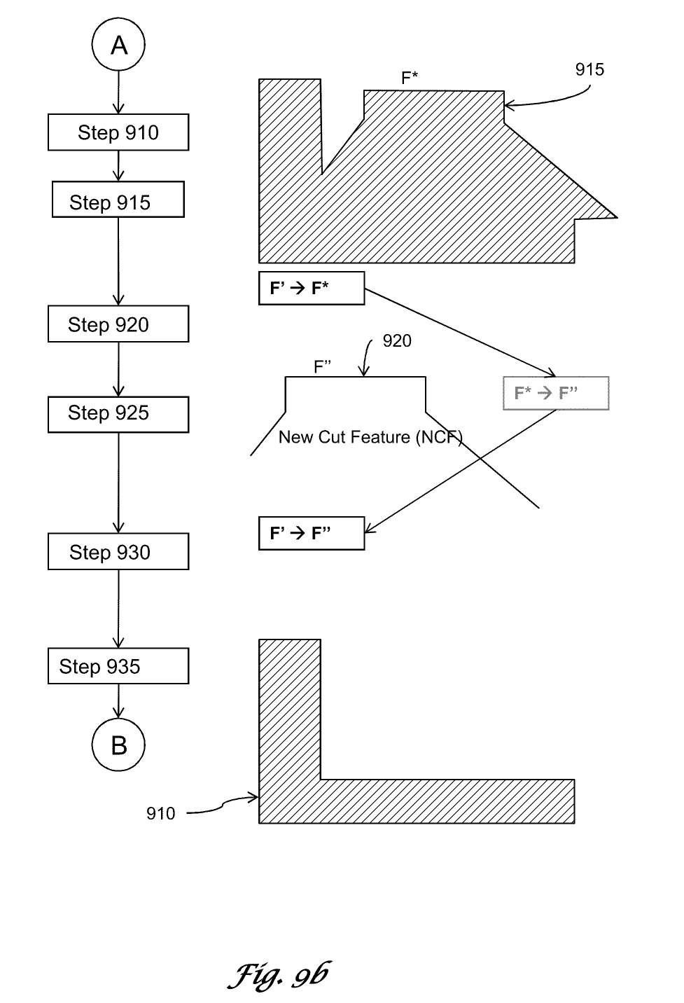

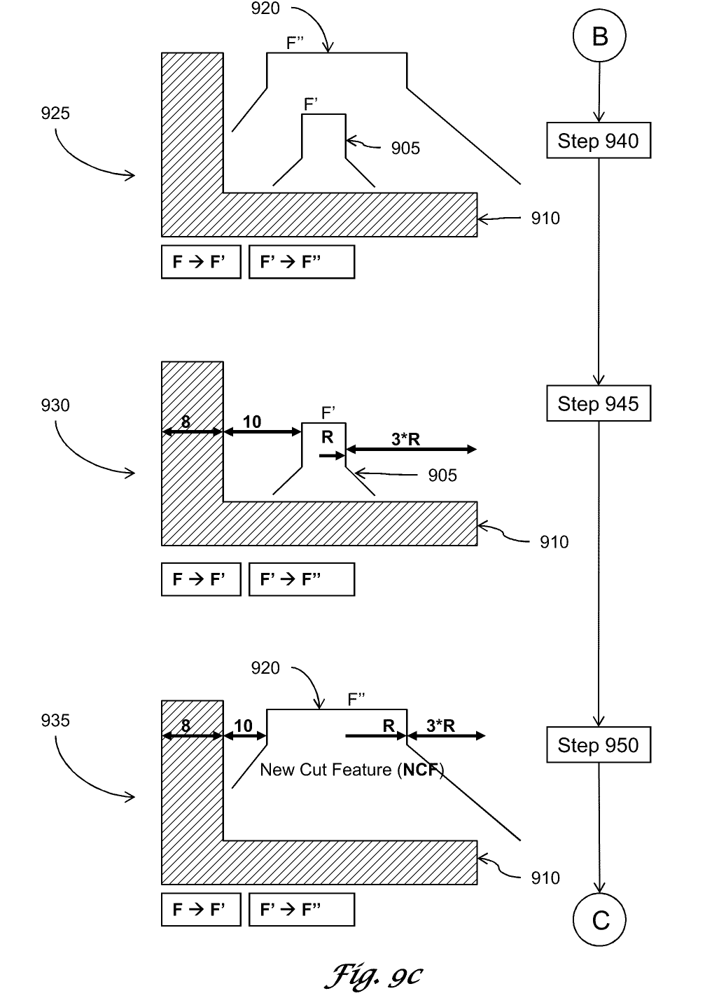

FIGS. 8a-d illustrate a general edit operation of an API in an exemplary solid model modification system. Referring further to FIGS. 8a-d, the interaction object 715 discussed above and corresponding sample pseudo-code can illustratively be explained by displaying an initial part 800 to modify by the designer 700 performing a general edit on a ribbed boss 805. The following table aligns the illustrative figures with respective pseudo-code:

| | | |
|---|---|---|
| Pseudo-Code | Step | Reference |

Select

| | | |
|---|---|---|
| ResultType res = ResultTypeOk | Step 800 | |
| <<designer 705 selects the ribbed boss 805>> | Step 805 | |
| Interaction Tag IT = CreateInteraction (&res); | | |
| Assert(result == ResultTypeOk); | Step 810 | 810 |
| InstanceTag instance 1 = CreateInstance(IT,&res) | | |
| FeatureTag FT = CreateFeature(IT); | Step 815 | 815 |
| FeatureSetRigid(IT,FT,TRUE); | | |

Find Relations

| | | |
|---|---|---|
| AddSelection(IT); | | |
| FindRelations(IT); | | |
| GetRelationCount(IT); | | |
| Loop { RelationTag relation = GetRelation(IT); } | | |
| RelationSetPriority(rel,Maintain); | Step 820 | 820, 825 |
| RelationSetPriority(rel,Maintain); | | |

Edit Dimension

| | | |
|---|---|---|
| <<designer 705 selects a modify dimension | Step 825 | |
| 830>> | | |
| RelationSetValue(IT,newval); | Step 830 | 835 |
| Update(IT); // to a new position 840 | Step 835 | |

Edit by drag

| | |
|---|---|
| FeatureSetRigid (IT,FT,TRUE); | Step 840 |

<<a mini-bar 845 provides a handle control 850>>

| | |
|---|---|
| LinearDrag Start (IT,POS,DIR,PICKPOS); | |
| LOOP | |
| { | |
| LinearDragStep(IT); | Step 845 |
| Update(IT); | |
| val = 2xRelationGetValue(IT,rel); | |
| } | |
| Update(IT); | Step 850 |
| 2xGetRelationValue(IT,re,&value); | |

Edit by Aligning to Cylinder

| | |
|---|---|
| FeatureSetRigid(IT,FT,TRUE); | Step 855 |

<<the mini-bar 845 provides a reference control >>

<<designer 700 intends to make the ribbed boss 805 concentric with a

curved corner 855>>

| | |
|---|---|
| R1 = GetReference(IT,F1,Instance1); | |
| R2 = CreateReference(IT,F2); | Step 860 |
| CreateRelation(IT,RelationTypeConcentric,R1, | |
| R2); | |
| RelationSetPriority(IT,rel,RelationPriorityFloat); | |

<<the ribbed boss 805 is moved to a concentric center>>

| | |
|---|---|
| Update(IT); | Step 865 |
| 2xRelationGetValue(IT,rel,&value); | |
| DestroyInteraction(IT); | |

### 5. A Method Illustration

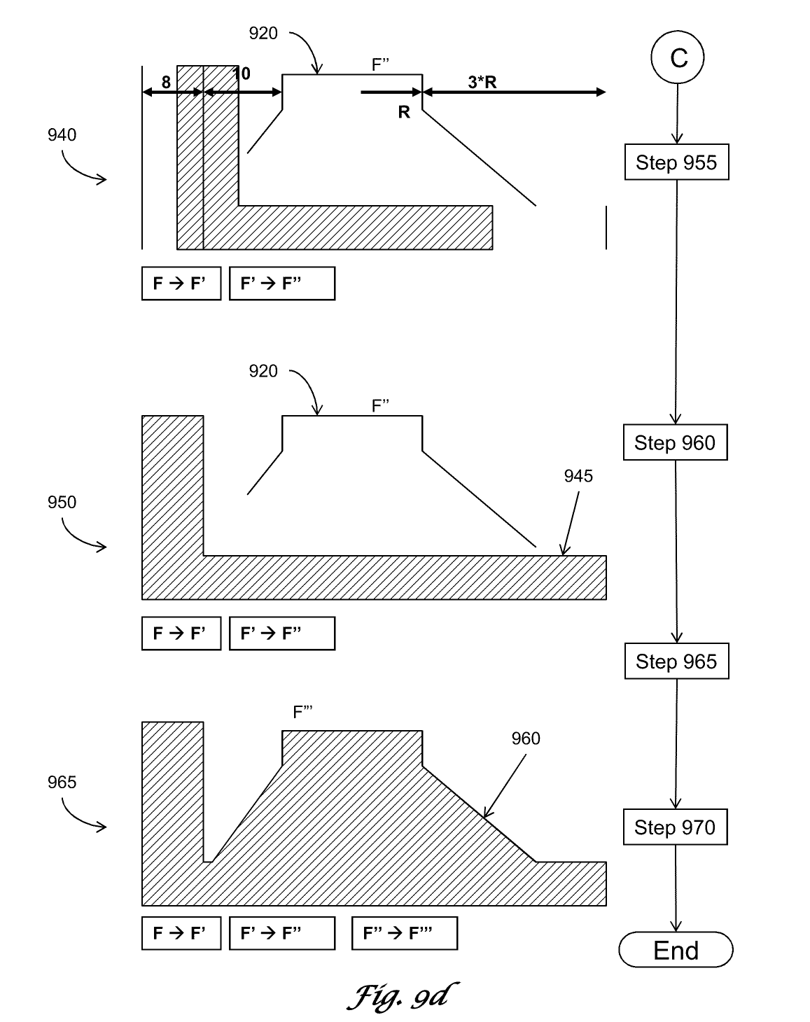

FIGS. 9a-d illustrates an algorithm for updating a procedural feature. Referring further to FIG. 9a, the initial part 800 is viewed in a two-dimensional (“2D′”) view to display an original body 900 of a profile of the initial part 800. To apply a parameter change to the ribbed boss 805, so for example to double the value for R, the ribbed boss 805 has to update as well as the rest of the initial part 800. As previously discussed, during the intent state 720 when the selection and recognition occur, the procedural feature that is the ribbed boss 805 is denoted by F in the original body 900 and is removed or cut off in an original cut feature (“OCF”) 905, denoted as F′, and stored as a sheet metal body (Step 900) using methods commonly understood in the art. For illustrative purposes the 2D view is utilized, however it is anticipated that 3D models are what the designer 700 will view. Continuing, the MappingData object preferably maps F to F′ for all faces of the feature (Step 905), where F′ in a cut feature sheet is equivalent to F in the original body 900 having a naked body (“NB”) 910 representing the original body 900 without the ribbed boss 805. The OCF, Map(F→F′), and NB are applied from the variational modeling toolkit 405 to the application 705 as part of the edit 725 where the designer 700 intends to a change dimension value edit. Referring further to FIG. 9b, the application 705 sets a mark M (Step 910) and applies a new feature pursuant to the desired edit (Step 915). The new feature is remapped (Step 920) to the naked body 910 to form a first regenerated body 915, denoted as F*. The new feature is removed or cut off the first regenerated body 915 and a new cut feature (“NCF”) 920, denoted as F″, is copied (Step 925) with the naked body 910 remaining. The original cut feature, F′, is remapped to the new feature faces, F″ (Step 930). The application 705 rolls back to M (Step 935). Referring further to FIG. 9c, the NCF and Map(F′→F″) is applied from the application 705 back to the variational modeling toolkit 405 for loading into the collection of geometric software component libraries 415 (Step 940), generally illustrated at 925. The collection of geometric software component libraries 415 calculates the radius and position of F′ in the OCF state, and also gathers the expected type changes from the Map(F′→F″) (Step 945), generally illustrated at 930. The collection of geometric software component libraries 415 calls the variational modeling toolkit 405 to place the OCF with the NCF in the support structures provided by the collection of geometric software component libraries 415, using Map(F′→F″) (Step 950), generally illustrated at 935. Referring further to FIG. 9d, the variational modeling toolkit 405 returns control to the collection of geometric software component libraries 415 so that the collection of geometric software component libraries 415 can position the remaining geometry based on the new procedural feature geometry (Step 955), generally illustrated at 940. The collection of geometric software component libraries 415 returns control back to the variational modeling toolkit 405 to apply any non-procedural changes to an applied naked body 945 (Step 960), generally illustrated at 950. The NCF 920 is applied to the applied naked body 945 with the features and associated new parameters into a final naked model state (Step 965), while generating a F″→F′″ map. A final body (FB) 960 is created, while merging maps (F→F′)+(F′→F″)=(F→F′″) that is returned to the application 705 as tracking information (Step 970), generally illustrated at 965.

### 6. Conclusion

The embodiment may be implemented in digital electronic circuitry, or in computer hardware, firmware, software, or in combinations thereof. An apparatus of the embodiment may be implemented in a computer program product tangibly embodied in a machine-readable storage device for execution by a programmable processor; and method steps of the embodiment may be performed by a programmable processor executing a program of instructions to perform functions of the embodiment by operating on input data and generating output.

The embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include numerous forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the embodiment. It is contemplated that geometry can be deletes, recreated and replaced by the aforesaid methods and system. Therefore, other implementations are within the scope of the following claims.

What is claimed is:

1. A system for modifying a solid model representation that is manipulated in a computer having software instructions for design, comprising:
a computer system, wherein the computer system includes a memory, a processor, a user input device, and a display device;
a computer generated geometric model stored in the memory in the memory of the computer system; and
wherein the computer system accesses at least one data file having a plurality of geometric model definitions; converts the geometric model definitions into a visual representation of a geometric model; identifies an edit feature for modification on a body of the geometric model; calculates a modified geometric model with the modified edit, wherein the computer system removes the edit feature from an original body of the geometric model; creates a mapping for a plurality of faces from the edit feature to a new edit feature; applies the new edit feature to the original body, wherein the new edit feature is remapped to a new body and the new body is modified; and integrates the new feature with the modified geometric model.

2. The system of claim 1, wherein the computer system displays the visual representation of the geometric model to a user.

3. The system of claim 1, wherein the removed edit feature is in a sheet metal format.

4. The system of claim 1, wherein the computer system saves a modified visual representation of the modified geometric model into the at least one data file.

5. The system of claim 1, wherein the at least one data file is one of a geometric modeler transmit file, a modeling toolkit information file, and a solid model part file.

6. The system of claim 1, wherein the visual representation is in a boundary representation format.

7. The system of claim 1, wherein the geometric model is a solid model.

8. The system of claim 1, wherein the computer system displays the modified geometric model to the user.

9. A computer program product, comprising a computer readable medium having computer readable program code embodied therein, the computer readable program code adapted to be executed in implement a method for modifying a solid model representation, the method comprising:
providing a system, wherein the system comprises distinct software modules, and wherein the distinct software modules comprise a model file processing module, a data display organization module, a logic processing module, a modification processing module, and a geometric model processing module;
parsing a plurality of model data files that specifies: a modeler transmit data used in a geometric modeling session, a modification information data applied to the geometric modeling session, and a model application data affected by the geometric modeling session, and wherein the parsing is performed by the model file processing module in response to being called by the logic processing module;
calculating a modified geometric model with a modified edit feature, wherein the calculating removes an edit feature from an original body of a geometric model, creates a mapping for a plurality of faces from the edit feature to a new edit feature, applies the new edit feature to an original body having been remapped to a new body that is modified, integrates the new edit feature with the modified geometric model, and is performed by the geometric model processing module in response to being called by the logic processing module;
organizing, by the data display organization module in response to being called by the logic processing module, the modified geometric model integrated with the new edit feature, wherein the organizing comprises utilizing the plurality of geometric conditions calculated by the logic processing module.

10. A method for modifying a solid model representation that is manipulated in a computer having software instructions for design, comprising:
accessing at least one data file having a plurality of geometric model definitions that define a geometric model;
converting the geometric model definitions into a visual representation of the geometric model;
identifying an edit feature for modification on a body of the geometric model; and
calculating a modified geometric model with the modified edit feature to display to the user; comprising the steps of:
removing the edit feature from an original body of the geometric model;
creating a mapping for a plurality of faces from the edit feature to a new edit feature;
applying the new edit feature to the original body, wherein the new edit feature is remapped to a new body and the new body is modified; and
integrating the new feature with the modified geometric model;

11. The method of claim 10, wherein the removed edit feature is in a sheet metal format.

12. The method of claim 10, further comprising displaying the visual representation of the geometric model to a user.

13. The method of claim 10, further comprising displaying the modified geometric model to the user.

14. The method of claim 10, further comprising saving a modified visual representation of the modified geometric model into the at least one data file.

15. The method of claim 10, wherein the at least one data file is one of a geometric modeler transmit file, a modeling toolkit information file, and a solid model part file.

16. The method of claim 10, wherein the visual representation is in a boundary representation format.

17. The method of claim 10, wherein the geometric model is a solid model.

18. A system for modifying a solid model representation that is manipulated in a computer having software instructions for design, comprising:
a computer system, wherein the computer system includes a memory, a processor, a user input device, and a display device;
a computer generated geometric model stored in the memory in the memory of the computer system; and
wherein the computer system accesses at least one data file that is one of a geometric modeler transmit file, a modeling toolkit information file, and a solid model part file, wherein the data file has a plurality of geometric model definitions that define a solid model; converts the solid model definitions into a boundary representation format of the solid model; displays the visual representation of the solid model to a user; identifies an edit feature for modification on a body of the solid model; calculates a modified solid model with the modified edit feature to display to the user, wherein the computer system removes the edit feature in a sheet metal format from an original body of the solid model; creates a mapping for a plurality of faces from the edit feature to a new edit feature; applies the new edit feature to the original body, wherein the new edit feature is remapped to a new body and the new body is modified; and integrates the new feature with the modified solid model; displays the modified solid model to the user; and saves a modified visual representation of the modified solid model into the at least one data file.
